(19) United States
(12) Patent Application Publication
(10) Pub. No.: US 2013/0076473 A1
(43) Pub. Date: Mar. 28, 2013

(54) TRANSFORMER

(71) Applicants: CHUN-KONG CHAN, NEW TAIPEI CITY (TW); KED LAN HUANG, NEW TAIPEI CITY (TW); CHI FANG LAI, NEW TAIPEI CITY (TW)

(72) Inventors: CHUN-KONG CHAN, NEW TAIPEI CITY (TW); KED LAN HUANG, NEW TAIPEI CITY (TW); CHI FANG LAI, NEW TAIPEI CITY (TW)

(73) Assignee: LIEN CHANG ELECTRONIC ENTERPRISE CO., LTD., NEW TAIPEI CITY (TW)

(21) Appl. No.: 13/244,324

(22) Filed: Sep. 24, 2011

(51) Int. Cl. H01F 27/30; H01F 27/32

(52) U.S. Cl. 336/198

(57) ABSTRACT

A transformer includes a bobbin, a primary coil, a secondary coil, and a core assembly. The bobbin has a winding portion. At least one first winding groove and at least one second winding groove are formed on the winding portion. The first winding groove and the second winding groove are separated by a barrier. A notch is formed on the fringe portion of the barrier. The primary coil is wrapped in the first winding groove, and the secondary coil is wrapped in the second winding groove. The notched barrier increases the creepage distance between the primary coil and the secondary coil in meeting the safety standards.

### BACKGROUND OF THE INVENTION

1. Field of the Invention

The instant disclosure relates to a transformer; more particularly, to a transformer having increased creepage distance between the primary side and the secondary side thereof for meeting enhanced safety compliance.

2. Description of the Related Art

Transformers play an important role in electrical circuits. Different safety standards are imposed on different transformers depending on specific application. In particular, various countries have adopted standards mandating minimum creepage distance between the primary and second sides thereof The creepage distance is defined as the shortest distance on the surface of an insulating material between two conductive components, such as the primary and secondary coils of a transformer. If the creepage distance is less than the required minimum value, a short circuit between the primary and second coils may occur.

The primary coil and the secondary coil are normally separated by a single barrier structure. The barrier should be thick enough to provide sufficient creepage distance to prevent short circuit. However, the increase in thickness means an increase for the overall height of the transformer. Such side effect is undesirable for miniaturization of the electronic devices.

To address the above issues, the inventors strive via industrial experience and academic research to present the instant disclosure, which can effectively improve the limitation described above.

### SUMMARY OF THE INVENTION

The instant disclosure provides a transformer capable of increasing the creepage distance. The safety standards can be met without increasing the thickness of the barrier, making the transformer useful for miniaturized electronic devices.

The instant disclosure also provides a transformer suitable for automatic winding operation. Namely, the primary and seconding coils can be created in one step.

The transformer of the instant disclosure comprises a bobbin, a primary coil, a secondary coil, and a core assembly. The bobbin has a first side portion and a second side portion formed oppositely thereon. A plurality of first pins is disposed on the first side portion, and a plurality of second pins is disposed on the second side portion. The bobbin has a winding portion, which has at least one first winding groove and at least one second winding groove formed thereon. The first winding groove and the second winding groove are separated by a barrier. A notch is formed on the barrier. The primary coil is wrapped in the first winding groove and connected to the first pins. The secondary coil is wrapped in the second winding groove and connected to the second pins. The core assembly is arranged on the bobbin.

The transformer of the instant disclosure has the following advantage. The notched barrier increases the creepage distance without increasing the wall thickness.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 is a perspective view of a bobbin of the instant disclosure.

FIG. 2 is a front view of the bobbin of the instant disclosure.

FIG. 3 is a top view of the bobbin of the instant disclosure.

FIG. 4 is a sectional view of the bobbin in FIG. 3 taken along a cutting-plane A-A.

FIG. 5 is a sectional view of the bobbin in FIG. 3 taken along a cutting-plane B-B.

FIG. 6 is a perspective view of the coiled bobbin of the instant disclosure.

FIG. 7 is a front view of the bobbin in FIG. 6.

FIG. 8 is a perspective view of a transformer of the instant disclosure.

FIG. 9 is a front view of the transformer in FIG. 8.

FIG. 10 is a perspective view of a core of the instant disclosure.

### DETAILED DESCRIPTION OF PREFFERED EMBODIMENTS

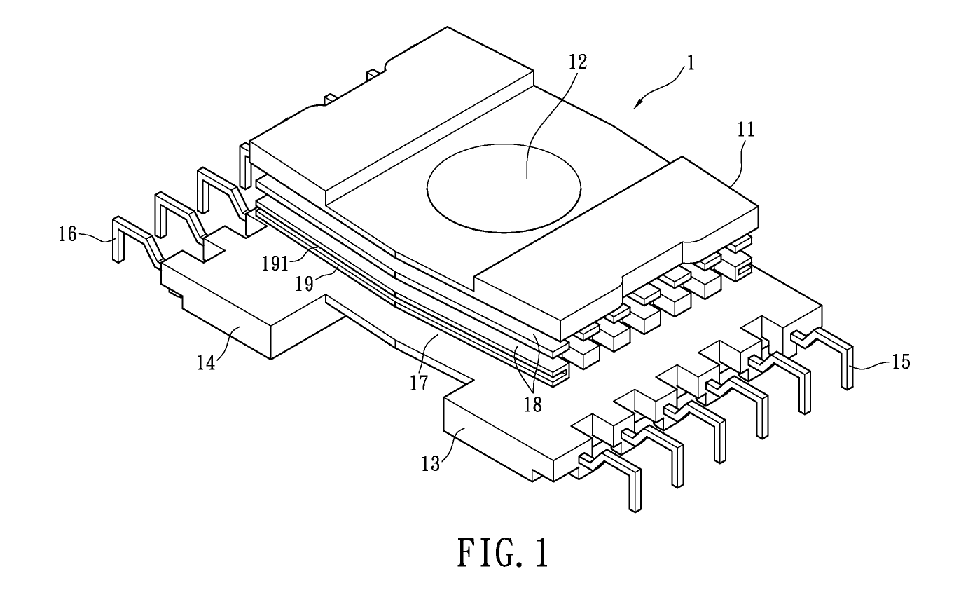

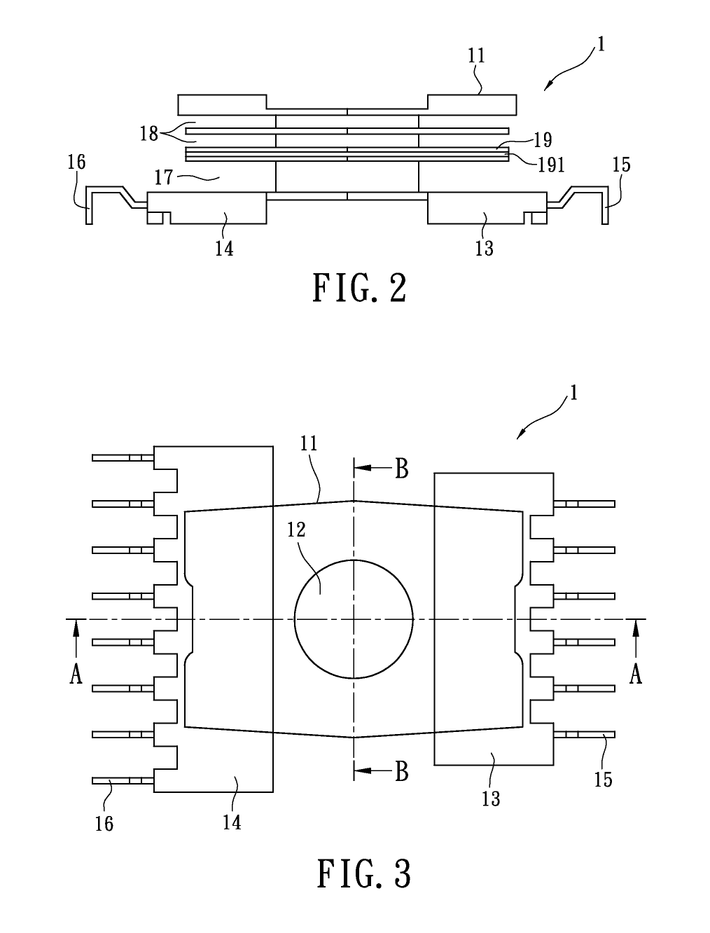

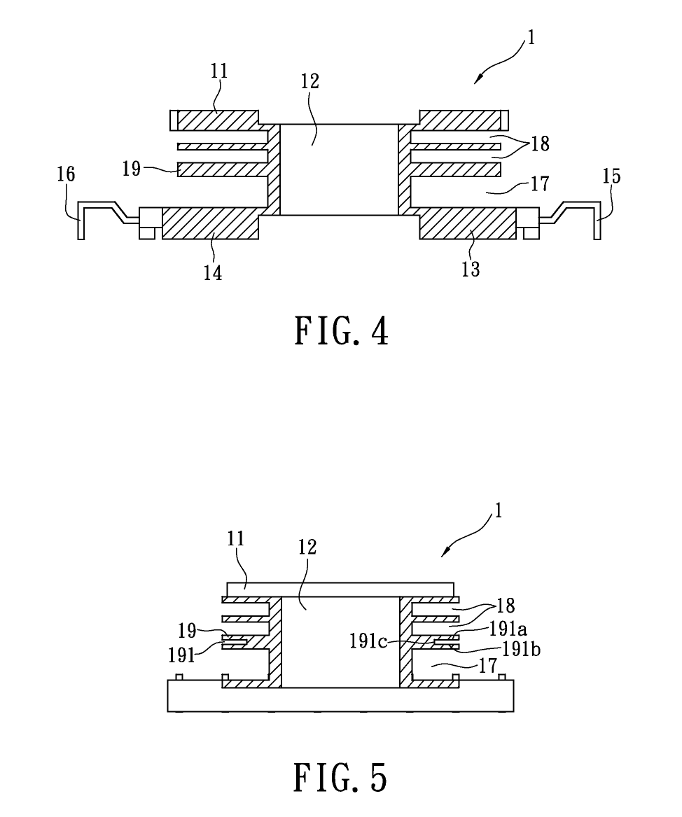

Please refer to FIGS. 1˜9, which show a transformer of the instant disclosure. The transformer comprises a bobbin 1, a primary coil 2, a secondary coil 3, and a core assembly 4. The bobbin 1 is formed of plastic or other insulators. The bobbin 1 has a hollowed winding portion 11 formed with a thru hole 12, as shown in FIGS. 1˜5. The central axis of the winding portion 11 extends vertically. A first side portion 13 and a second side portion 14 are formed oppositely on the winding portion 11. A plurality of first pins 15 and a plurality of second pins 16 are disposed on the first side portion 13 and the second side portion 14, respectively. The first and second pins 15 and 16 may be shaped in a right angle or have multiple curved sections. The structural configuration of the bobbin 1 is not restricted but can be varied accordingly.

At least one first winding groove 17 and at least one second winding groove 18 are formed on the winding portion 11. The number of first winding grooves 17 and second winding grooves 18 is not restricted. For the instant embodiment, the winding portion 11 has one first winding groove 17 and a pair of second winding grooves 18 formed thereon. The second winding grooves 18 are formed above the first winding groove 17. The first winding groove 17 and the second winding grooves 18 are separated by a barrier 19, which can be rectangular-shaped or have any other shapes. As illustrated in FIG. 5, a notch 191 is formed on the barrier 19. The resulting recessed surface of the barrier 19 increases the creepage distance between the primary and secondary coils 2 and 3. With respect to FIG. 5, the recessed surface of the barrier 19 is defined by a top surface 191a, a bottom surface 191b, and a side surface 191c. The top surface 191a is connected to the bottom surface 191b by the side surface 191c. The shape of the notch 191 is not restricted.

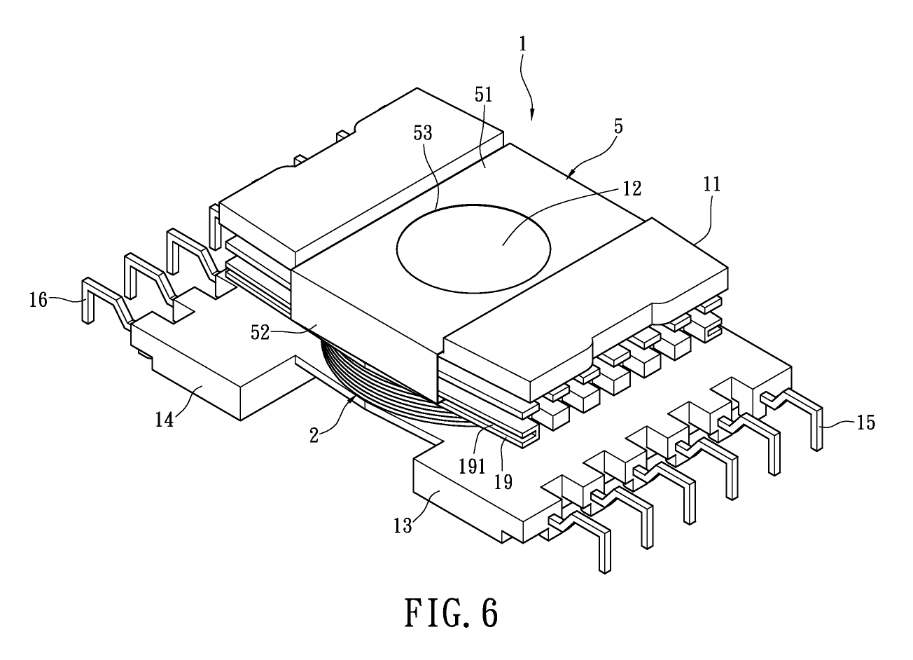

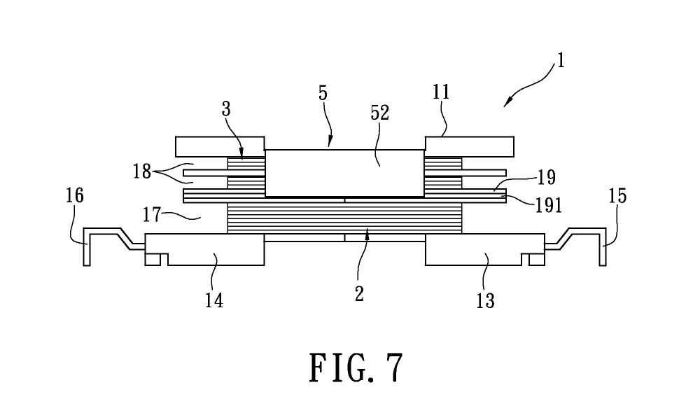

As shown in FIGS. 6 and 7, the primary coil 2 is wrapped in the first winding groove 17 and connected (not shown) to the first pins 15. The secondary coil 3 is wrapped in the second winding grooves 18 and connected (not shown) to the second pins 16.

The transformer can further include an insulating cover 5. Like the bobbin 1, the insulating cover 5 is formed of plastic or other insulators. The structural configuration of the insulating cover 5 is not restricted either. As shown in FIG. 6, the insulating cover 5 has an upper wall 51 and two side walls 52 extended therefrom. A via hole 53 is projected through the upper wall 51 to accommodate a core assembly 4. The insulating cover 5 can be arranged on the bobbin 1, such that the insulating cover 5 is between the core assembly 4 and the secondary coil 3 for separation.

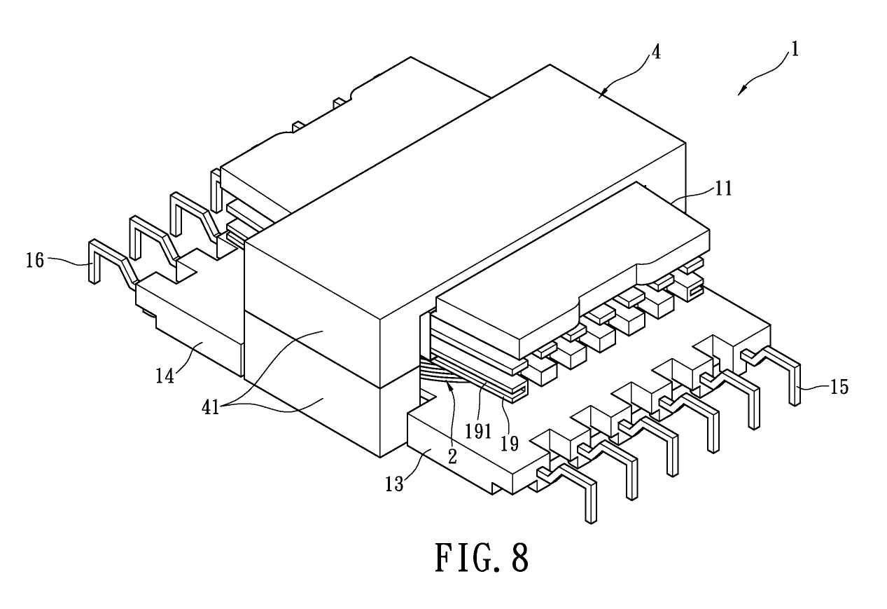

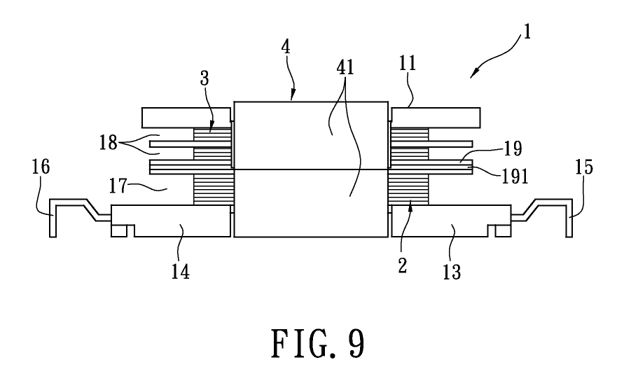

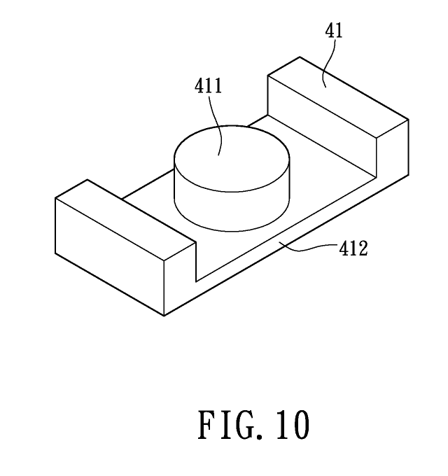

The core assembly 4 can be arranged on the bobbin 1, as shown in FIGS. 8 and 9. The core assembly 4 includes a pair of matching cores 41, which can be E-shaped. The bobbin 1 is sandwiched between the two cores 41. As shown in FIG. 10, each core 41 has a inner portion 411 for inserting into the thru hole 12 of the winding portion 11. Each core 41 also has an exposed outer portion 412 in forming a magnetic circuit with the inner portion 411. The outer portions 412 are arranged surroundingly around the primary coil 2 and the secondary coil 3. The structural configuration of the core assembly 4 is not restricted.

It can therefore be seen that the notch 191 formed on the barrier 19 increases the creepage distance. The safety standards are met without compromising the thickness of the barrier 19, making the transformer useful for miniaturization of the electronic products.

Moreover, the insulating cover can be easily fitted onto the bobbin 1, thereby removing the need of wrapping any insulating tape. In addition, a fully automatic winding machine can be used to wrap the primary coil 2 and the secondary coil 3 all in one step. The coil wrapping process can be expedited to save cost.

The descriptions illustrated supra set forth simply the preferred embodiment of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims

What is claimed is:

1. A transformer, comprising:
a bobbin having an opposing arranged first side portion and a second side portion, wherein a plurality of first pins is disposed on the first side portion and a plurality of second pins is disposed on the second side portion, wherein the bobbin has a winding portion, wherein at least one first winding groove and at least one second winding groove are defined on the winding portion and separated by a barrier, wherein a notch is formed on the barrier;
a primary coil wrapped in the first winding groove and connected to the first pins;
a secondary coil wrapped in the second winding groove and connected to the second pins; and
a core assembly disposed on the bobbin.

2. The transformer of claim 1, wherein an insulating cover is disposed on the bobbin between the core assembly and the secondary coil.

3. The transformer of claim 2, wherein the insulating cover has an upper wall and two side walls extended oppositely therefrom, wherein a via hole is projected through the upper wall to accommodate the core assembly.

4. The transformer of claim 1, wherein the core assembly includes a pair of matching cores fitted onto the bobbin.

5. The transformer of claim 4, wherein a thru hole is formed on the winding portion, wherein each core has an inner portion for protruding into the thru hole, and has an outer portion arranged in exposure and connected to the inner portion, and wherein the outer portion is arranged surroundingly around the primary coil and the secondary coil.

6. The transformer of claim 1, wherein the central axis of the winding portion extends in the vertical direction.

7. The transformer of claim 6, wherein the number of second winding grooves is two, and wherein the second winding grooves are formed above the first winding groove.

8. The transformer of claim 1, wherein the notch is defined by a top surface, a bottom surface, and a side surface, and wherein the top surface is connected to the bottom surface through the side surface.
